(19) United States
(12) Patent Application Publication
(10) Pub. No.: US 2026/0157935 A1
(43) Pub. Date: Jun. 11, 2026

(54) ELECTRONICALLY ENABLED PILL ORGANIZER

(71) Applicant: 9494-1861 Québec Inc., Laval (CA)

(72) Inventors: Pier-Luc TARDIF, Laval (CA); Jean-Claude TARDIF, Laval (CA)

(21) Appl. No.: 19/126,720

(22) PCT Filed: Nov. 3, 2023
(86) PCT No.: PCT/CA2023/051472

§ 371 Date: May 2, 2025

Related U.S. Application Data
(60) Provisional application No. 63/422,504, filed on Nov. 4, 2022.

(51) Int. Cl. A61J 7/04; A61J 7/00

(52) U.S. Cl. CPC A61J 7/0436; A61J 7/0084; A61J 7/0481; A61J 2200/30; A61J 2200/70; A61J 2205/40; A61J 2205/70

(57) ABSTRACT

A medication container for medication compliance comprises a housing having a plurality of compartments, wherein each compartment has an indicator and a lid. The container also has an optical sensor disposed on the housing or on at least one lid, to sense ambient light thus detecting the user use of the medication. The lid has a sensor cover for shielding the optical sensor from ambient light when the at least one lid is closed. A processor and a transmitter relay and receive sensor signals and alerts regarding the use of medication to aid in medication compliance.

### BACKGROUND OF THE INVENTION

Medication adherence is challenging for patients who need to take medication as part of their daily routine. Existing pill organizers are not sufficiently effective in aiding patients in maintaining medication adherence. Further, existing pill organizers are not sufficiently effective in facilitating caregiver and healthcare professional monitoring of the patient's medication adherence.

There continues to be a need for pill organizers that help patients maintain a prescribed medication regimen.

### SUMMARY OF THE DISCLOSURE

The present disclosure relates to pill organizers useful for storing medication. More particularly, the present disclosure relates to pill organizers for aiding in the maintenance of medication adherence through pre-programmed medication schedules which generate alerts for the patient to take a particular dose and to monitor the patient's compliance with a prescribed medication regimen.

In a first aspect, the present disclosure features a medication container including: a housing including a plurality of compartments, in which each compartment includes (i) an indicator and (ii) a lid, in which each lid includes an inner surface; an optical sensor disposed on the housing or on at least one lid; a sensor cover configured to shield the optical sensor from ambient light when the at least one lid is closed; a processor; and a transmitter; in which the sensor cover is configured to mate with the sensor upon closure of the at least one lid.

In some embodiments, each compartment or lid includes an optical sensor.

In some embodiments, each compartment or lid includes a sensor cover. In some embodiments, the sensor cover is concave, curved, rounded, triangular, rectangular, or cuboidal.

In some embodiments, the sensor cover includes a protrusion. In some embodiments, the sensor cover is configured to nestably or slidably mate with the optical sensor.

In some embodiments, the sensor cover includes a sensor cavity. In some embodiments, the optical sensor is configured to nestably mate with the sensor cavity. In some embodiments, the volume of the cavity is no more than 25%, 20%, 15%, 10%, 5%, or 1% larger than the volume of the optical sensor.

In some embodiments, the optical sensor is in a cavity. In some embodiments, the sensor cover is configured to cover or fill the cavity upon closure of at least one lid. In some embodiments, the volume of the cavity above the optical sensor is no more than 25%, 20%, 15%, 10%, 5%, or 1% larger than the volume of the sensor cover.

In some embodiments, upon closure of the lid, the sensor cover conforms to the shape of the optical sensor. In some embodiments, upon closure of the lid, the optical sensor is substantially surrounded by the sensor cover.

In some embodiments, the optical sensor is disposed on at least one inner surface. In some embodiments, the optical sensor is disposed in at least one compartment.

In some embodiments, the sensor cover is disposed on the housing. In some embodiments, the sensor cover is disposed in at least one compartment. In some embodiments, the sensor cover is disposed on at least one inner surface.

In some embodiments, the sensor cover includes a light filter. In some embodiments, the light filter blocks greater than 50%, 60%, 70%, 80%, 90%, 95%, or 99% of ambient light.

In some embodiments, the optical sensor includes a sensor surface. In some embodiments, the sensor surface is rounded or flat.

In some embodiments, the sensor surface allows transmission of greater than 50%, 60%, 70%, 80%, 90%, 95%, or 99% of ambient light.

In some embodiments, each lid is hingeably attached to the housing.

In some embodiments, each lid is slidably attached to the housing. In some embodiments, the housing includes a groove through which at least one lid is configured to slide. In some embodiments, the sensor cover is configured to slidably engage the optical sensor.

In some embodiments, the sensor cover is integral to the lid or housing. In some embodiments, the sensor cover is removably attached to the lid or housing. In some embodiments, the sensor cover clips, snaps, or screws into the lid or housing.

In some embodiments, the optical sensor is a photoresistor. In some embodiments, the optical sensor is a charge-coupling device (CCD) or a complementary metal-oxide-semiconductor (CMOS).

In some embodiments, the indicator is a symbol, a light emitting diode (LED), an embossment, or an indent. In some embodiments, the embossment is Braille. In some embodiments, the symbol is a letter or number corresponding to the day of the week or month. In some embodiments, the indicator is on at least one lid or compartment. In some embodiments, the housing or at least one lid includes at least one LED. In some embodiments, each compartment and/or each lid includes an LED.

In some embodiments, the housing includes from 2 to 30 compartments (e.g., from 2 to 5, from 2 to 7, from 2 to 10, from 2 to 15, from 2 to 20, from 5 to 7, from 5 to 15, from 7 to 14, from 10 to 20, from 15 to 30, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30). In some embodiments, the housing includes 7 or 14 compartments. In some embodiments, the housing includes 7 compartments. In some embodiments, the housing includes 14 compartments. In some embodiments, the plurality of compartments are configured for receiving one or more medications.

In some embodiments, each lid includes a button or switch to open the corresponding compartment.

In some embodiments, the processor is configured to determine a positive or negative medication adherence event by a subject based on at least one measurement taken by the optical sensor.

In some embodiments, the processor is configured to receive a signal from an external device. In some embodiments, the transmitter is configured to wirelessly send a signal to an external device. In some embodiments, the signal corresponds to a positive or a negative medication adherence event. In some embodiments, the signal is an alert to a caregiver or healthcare professional regarding a positive or negative medication adherence event.

In some embodiments, the transmission element is a BLUETOOTH® transmission element.

In some embodiments, the processor is configured to turn on an LED based on a medication regime received from an external device, in which the LED corresponds to a medication to be taken by a subject. In some embodiments, each compartment or lid includes an LED.

In some embodiments, the processor is configured to send a reminder of a scheduled medication dose to a subject.

In some embodiments, the medication container further includes an auditory alert, and in which the processor is configured to turn on the auditory alert based on the medication regime received from an external device. In some embodiments, the auditory alert is bell, chime, or buzzer.

In some embodiments, the external device is a personal computer, a tablet, a cellular phone, a pharmacy computer, or a patient information database. In one embodiment, the external device is a cellular phone. In another embodiment, the external device is a tablet.

In some embodiments the housing comprises a plurality of compartments, wherein each compartment comprises an indicator, a lid, an optical sensor, and a sensor cover configured to shield the optical sensor from ambient light when the lid is closed, wherein the lid is hingeably attached to the housing.

In some embodiments the housing comprises a plurality compartments, wherein each compartment comprises an indicator, an optical sensor, and a lid comprising a sensor cover configured to shield the optical sensor from ambient light when the lid is closed, wherein the lid is hingeably attached to the housing.

In some embodiments the housing comprises 14 compartments, wherein each compartment comprises an indicator, a lid, an optical sensor, and a sensor cover configured to shield the optical sensor from ambient light when the lid is closed, wherein the lid is hingeably attached to the housing.

In some embodiments the housing comprises 14 compartments, wherein each compartment comprises an indicator, an optical sensor, and a lid comprising a sensor cover configured to shield the optical sensor from ambient light when the lid is closed, wherein the lid is hingeably attached to the housing.

In some embodiments the housing comprises a plurality of compartments, wherein each compartment comprises an indicator, a lid, an optical sensor, and a sensor cover configured to shield the optical sensor from ambient light when the lid is closed, wherein the lid is hingeably attached to the housing, and wherein the indicator is a LED.

In some embodiments the housing comprises a plurality compartments, wherein each compartment comprises an indicator, an optical sensor, and a lid comprising a sensor cover configured to shield the optical sensor from ambient light when the lid is closed, wherein the lid is hingeably attached to the housing, and wherein the indicator is a LED.

In some embodiments the housing comprises 14 compartments, wherein each compartment comprises an indicator, a lid, an optical sensor, and a sensor cover configured to shield the optical sensor from ambient light when the lid is closed, wherein the lid is hingeably attached to the housing, and wherein the indicator is a LED.

In some embodiments the housing comprises 14 compartments, wherein each compartment comprises an indicator, an optical sensor, and a lid comprising a sensor cover configured to shield the optical sensor from ambient light when the lid is closed, wherein the lid is hingeably attached to the housing, and wherein the indicator is a LED.

In a second aspect, the present disclosure features a method of monitoring medication compliance, including (i) providing the medication container of any of the devices of the first aspect; (ii) providing a medication schedule to the processor from a first external device; (ii) sensing ambient light with the optical sensor, in which ambient light corresponds to a positive medication incident; and (iii) sending a signal to the first external device or a second external device with the transmitter, in which the signal corresponds to the positive medication incident.

In some embodiments, the medication schedule includes a scheduled medication dose, in which the medication container includes at least one LED, and in which the processor turns on the LED prior to a scheduled medication dose. In some embodiments, the medication schedule includes a scheduled medication dose, in which the medication container includes an auditory alert, and in which the processor turns on the auditory alert prior to a scheduled medication dose.

In some embodiments, the auditory alert is bell, chime, or buzzer. In some embodiments, the auditory alert includes a speaker.

In some embodiments, the first and/or the second external device is a personal computer, a tablet, a cellular phone, a pharmacy computer, or a patient information database.

In some embodiments, the signal is sent to an external computer of a caregiver or healthcare professional. In some embodiments, the external computer is a personal computer, a cellular phone, a tablet, or a speaker.

In some embodiments, the medication schedule is provided to the processor by a patient.

### DEFINITIONS

To facilitate the understanding of this disclosure, a number of terms are defined below. Terms defined herein have meanings as commonly understood by a person of ordinary skill in the areas relevant to the disclosure. Terms such as “a”, “an,” and “the” are not intended to refer to only a singular entity, but include the general class of which a specific example can be used for illustration. The terminology herein is used to describe specific embodiments of the disclosure, but their usage does not limit the disclosure, except as outlined in the claims.

As used herein, the term “about” refers to a value that is within 10% above or below the value being described.

As used herein, any values provided in a range of values include both the upper and lower bounds, and any values contained within the upper and lower bounds.

### BRIEF DESCRIPTION OF THE DRAWINGS

The following detailed description of the embodiments of the invention may be better understood when read in conjunction with the appended drawings. It should be understood, however, that the invention is not limited to the precise arrangement and instrumentalities of the embodiments shown in the drawings.

FIG. 1 is an image showing an isometric view of an embodiment of medication container 100, including housing 110 and lid 120, as well as a button 180 and plurality of indicators 150.

FIG. 2 is an image showing an enlarged view of an embodiment of medication container 100, including closed lid 120, indicator letter 151, indicator image 152, indicator embossment 153, indicator light 154, button 180, and plug 185.

FIG. 3 is a series of images showing enlarged views of an embodiment of medication container 100, including open lid 120, housing 110 having upper surface 115, compartment 111 having inner surface 112, optical sensor 130, and sensor cover 140.

FIG. 4 is an image showing an isometric view of an embodiment of medication container 100 without lid 120. FIG. 4 shows a plurality of optical sensors 130.

FIG. 5 is a series of drawings showing three cross-sectional views of medication container 100, including compartment 111 having pill 10 disposed therein, optical sensor 130 including emitter 132 and detector 133. FIG. 5 shows that detector 133 detects light 20 emitted from emitter 132. FIG. 5 further shows that pill 10 blocks emitted light 20 from emitter 132 such that detector 133 cannot detect it.

### DETAILED DESCRIPTION

Featured herein are devices and methods of use thereof for the maintenance of medication adherence.

### Medication Container

Medication containers of the disclosure include a housing including a plurality of compartments, in which each compartment includes (i) an indicator and (ii) a lid, in which each lid includes an inner surface; an optical sensor disposed on the housing or on at least one lid; a sensor cover configured to shield the optical sensor from ambient light; a processor; and a transmitter; in which the sensor cover is configured to mate with the sensor upon closure of at least one lid.

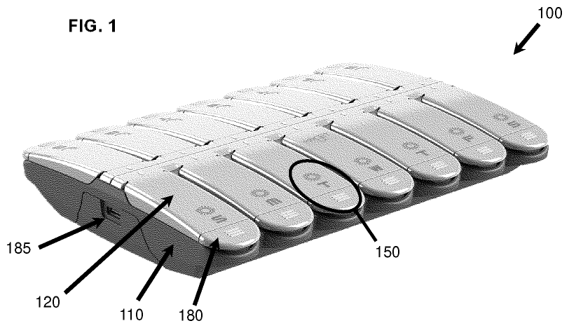

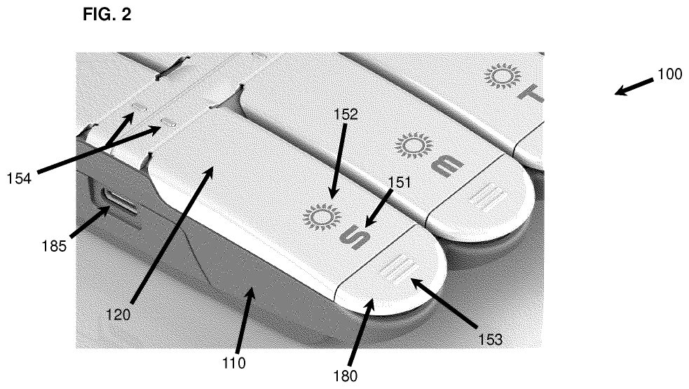

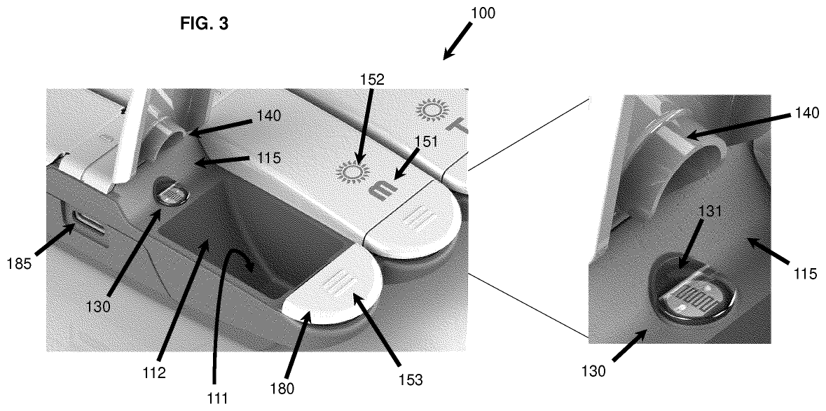

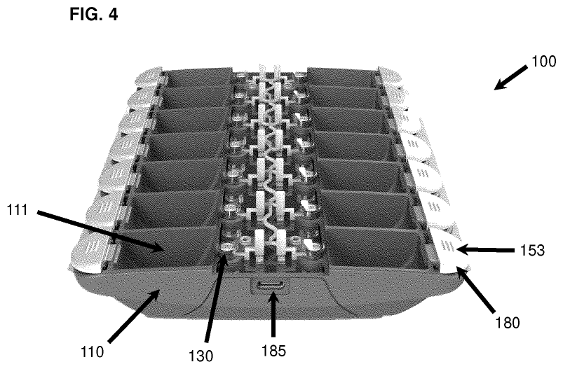

FIG. 1, FIG. 2, FIG. 3, and FIG. 4 show exemplary medication container 100. Medication container 100 includes housing 110 having upper surface 115, compartments 111 having inner surfaces 112, lids 120, optical sensors 130, sensor covers 140, buttons 180, and plug 185. FIG. 1, FIG. 2, and FIG. 3 further show a plurality of indicators, including indicator letter 151, indicator image 152, indicator embossment 153, and indicator light 154.

In particular, FIG. 1 shows medication container 100, including housing 110 and lid 120, button 180 and plurality of indicators 150. FIG. 2 shows an enlarged view of medication container 100 of FIG. 1, including closed lid 120, indicator letter 151, indicator image 152, indicator embossment 153, indicator light 154, button 180, and plug 185. FIG. 3 shows enlarged view of medication container 100 of FIG. 1, including open lid 120, housing 110 having upper surface 115, compartment 111 having inner surface 112, optical sensor 130, and sensor cover 140. FIG. 4 shows medication container 100, including housing 110 without lid 120. FIG. 4 shows a plurality of optical sensors 130.

### Housing

Medication container 100 has housing 110 including a plurality of compartments 111, as shown in FIG. 3. The plurality of compartments 111 are configured for receiving one or more medications in the form of pills 10, tablets, or capsules. Housing 110 includes upper surface 115 from which compartments 111 extend downward. Each compartment 111 includes inner surface 112, onto which one or more pills 10, tablets, or capsules can be placed. Inner surface 112 can be rough, dimpled, or smooth.

Housing 110 can be formed from a single piece or a plurality of pieces. For example, medication container 100 can include a first piece including compartments 111 and a second piece including electrical elements, such as plug 185, power source, a processor, and/or a transmitter. The pieces can be snapped, slid, or secured together, such as with adhesive or fasteners, such as screws. In some embodiments, housing 110 includes a polymeric material. In some embodiments, the polymeric material is acrylic (PMMA), acrylonitrile butadiene styrene (ABS), nylon polyamide (PA), polycarbonate (PC), polyethylene (PE), polyoxymethylene (POM), polypropylene (PP), polystyrene (PS), thermoplastic elastomer (TPE), thermoplastic polyurethane (TPU), or a combination thereof. In some embodiments, housing 110 can be fabricated through injection molding or additive manufacturing, such as 3D-printing. Housing 110 can include from 1 to 50 (e.g., from 1 to 2, from 1 to 3, from 1 to 4, from 1 to 5, from 1 to 6, from 1 to 7, from 1 to 8, from 1 to 9, from 1 to 10, from 1 to 11, from 1 to 12, from 1 to 13, from 1 to 14, from 1 to 15, from 1 to 16, from 1 to 17, from 1 to 18, from 1 to 19, from 1 to 20, from 2 to 3, from 2 to 4, from 2 to 5, from 2 to 6, from 4 to 8, from 4 to 10, from 4 to 12, from 4 to 16, from 2 to 14, from 2 to 16, from 2 to 18, from 2 to 18, from 2 to 20, from 2 to 22, from 2 to 24, from 5 to 8, from 5 to 7, from 5 to 10, from 6 to 8, from 6 to 10, from 6 to 12, from 6 to 14, from 6 to 16, from 6 to 18, from 6 to 20, from 6 to 22, from 6 to 24, from 7 to 14, from 8 to 10, from 8 to 12, from 8 to 14, from 8 to 16, from 8 to 18, from 8 to 20, from 8 to 22, from 8 to 24, from 10 to 12, from 10 to 14, from 10 to 16, from 10 to 18, from 10 to 20, from 10 to 22, from 10 to 24, from 10 to 30, from 10 to 40, from 10 to 50, from 12 to 14, from 12 to 16, from 12 to 18, from 12 to 20, from 12 to 22, from 12 to 24, from 14 to 16, from 14 to 18, from 14 to 20, from 14 to 22, from 14 to 24, from 16 to 20, from 16 to 32, from 20 to 40, from 30 to 40, from 30 to 50, from 40 to 50, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50) compartments. In some embodiments, housing 110 includes 7 or 14 compartments 111. In some embodiments, housing 110 includes 7 compartments 111, such as one for each day of the week. In some embodiments, housing 110 includes 14 compartments 111, such as two for each day of the week.

In some embodiments, compartments 111 are distributed in columns and rows. In some embodiments, medication container 100 includes from 1 to 10 columns (e.g., from 1 to 2, from 1 to 3, from 1 to 4, from 1 to 5, from 2 to 3, from 2 to 4, from 4 to 6, from 5 to 10, 1, 2, 3, 4, 5, 6, 7, 8, 9, or 10).

In some embodiments, medication container 100 includes from 1 to 10 rows (e.g., from 1 to 2, from 1 to 3, from 1 to 4, from 1 to 5, from 2 to 3, from 2 to 4, from 4 to 6, from 5 to 10, 1, 2, 3, 4, 5, 6, 7, 8, 9, or 10).

FIG. 1 shows medication container 100 having 14 compartments 111, distributed in 7 columns and 2 rows. In some embodiments, each compartment 111 in a column is closed with a separate lid 120. In some embodiments, each compartment 111 in a row is closed with a separate lid 120.

Each compartment 111 can include a volume from about 5 mL to about 100 mL (e.g., from about 5 mL to about 10 mL, from about 5 mL to about 15 mL, from about 5 mL to about 20 mL, from about 5 mL to about 25 mL, from about 5 mL to about 30 mL, from about 5 mL to about 35 mL, from about 5 mL to about 40 mL, from about 5 mL to about 45 mL, from about 5 mL to about 50 mL, from about 5 mL to about 60 mL, from about 5 mL to about 70 mL, from about 5 mL to about 75 mL, from about 5 mL to about 80 mL, from about 5 mL to about 90 mL, from about 10 mL to about 15 mL, from about 10 mL to about 20 mL, from about 10 mL to about 25 mL, from about 10 mL to about 30 mL, from about 10 mL to about 40 mL, from about 10 mL to about 50 mL, from about 10 mL to about 60 mL, from about 10 mL to about 70 mL, from about 10 mL to about 80 mL, from about 10 mL to about 90 mL, from about 10 mL to about 100 mL, from about 15 mL to about 20 mL, from about 15 mL to about 25 mL, from about 15 mL to about 30 mL, from about 15 mL to about 40 mL, from about 15 mL to about 50 mL, from about 20 mL to about 25 mL, from about 20 mL to about 30 mL, from about 20 mL to about 35 mL, from about 20 mL to about 40 mL, from about 20 mL to about 50 mL, from about 25 mL to about 35 mL, from about 25 mL to about 50 mL, from about 25 mL to about 75 mL, from about 25 mL to about 100 mL, from about 30 mL to about 35 mL, from about 30 mL to about 40 mL, from about 30 mL to about 45 mL, from about 30 mL to about 50 mL, from about 30 mL to about 60 mL, from about 30 mL to about 75 mL, from about 30 mL to about 100 mL, from about 35 mL to about 40 mL, from about 35 mL to about 45 mL, from about 35 mL to about 50 mL, from about 35 mL to about 60 mL, from about 40 mL to about 50 mL, from about 40 mL to about 60 mL, from about 50 mL to about 75 mL, from about 50 mL to about 100 mL, from about 60 mL to about 75 mL, from about 70 mL to about 90 mL, from about 80 mL to about 100 mL, or from about 90 mL to about 100 mL, about 5 mL, about 10 mL, about 15 mL, about 20 mL, about 25 mL, about 30 mL, about 35 mL, about 40 mL, about 45 mL, about 50 mL, about 55 mL, about 60 mL, about 65 mL, about 70 mL, about 75 mL, about 80 mL, about 85 mL, about 90 mL, about 95 mL, or about 100 ml). In one embodiment, the volume is about 15 mL. The volume of each compartment 111 is defined as the space between inner surface 112 and a plane at upper surface 115.

In some embodiments, an opening to compartment 111 includes a polygonal (e.g., square or rectangular), elliptical (e.g., round or oval), triangular, or amorphous shape.

In some embodiments, each compartment 111 includes a length and a width.

In some embodiments, the width of each compartment 111 can be from about 10 mm to about 150 mm (e.g., from about 10 mm to about 20 mm, from about 10 mm to about 25 mm, from about 10 mm to about 30 mm, from about 10 mm to about 40 mm, from about 10 mm to about 50 mm, from about 10 mm to about 75 mm, from about 10 mm to about 100 mm, from about 15 mm to about 25 mm, from about 15 mm to about 30 mm, from about 15 mm to about 50 mm, from about 20 mm to about 25 mm, from about 20 mm to about 30 mm, from about 20 mm to about 40 mm, from about 20 mm to about 50 mm, from about 25 mm to about 35 mm, from about 25 mm to about 50 mm, from about 25 mm to about 75 mm, from about 25 mm to about 100 mm, from about 30 mm to about 35 mm, from about 30 mm to about 40 mm, from about 30 mm to about 45 mm, from about 30 mm to about 50 mm, from about 30 mm to about 60 mm, from about 30 mm to about 75 mm, from about 30 mm to about 100 mm, from about 35 mm to about 40 mm, from about 35 mm to about 45 mm, from about 35 mm to about 50 mm, from about 35 mm to about 60 mm, from about 40 mm to about 50 mm, from about 40 mm to about 60 mm, from about 50 mm to about 75 mm, from about 50 mm to about 90 mm, from about 50 mm to about 100 mm, from about 50 mm to about 150 mm, from about 60 mm to about 75 mm, from about 60 mm to about 80 mm, from about 60 mm to about 100 mm, from about 70 mm to about 80 mm, from about 70 mm to about 100 mm, from about 75 mm to about 100 mm, from about 75 mm to about 125 mm, from about 100 mm to about 150 mm, from about 125 mm to about 150 mm, about 10 mm, about 15 mm, about 20 mm, about 23 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 110 mm, about 120 mm, about 130 mm, about 140 mm, or about 150 mm). In one embodiment, the width is about 23 mm.

In some embodiments, the length of each compartment 111 is from about 10 mm to about 150 mm (e.g., from about 10 mm to about 20 mm, from about 10 mm to about 25 mm, from about 10 mm to about 30 mm, from about 10 mm to about 40 mm, from about 10 mm to about 50 mm, from about 10 mm to about 75 mm, from about 10 mm to about 100 mm, from about 15 mm to about 25 mm, from about 15 mm to about 30 mm, from about 15 mm to about 50 mm, from about 20 mm to about 30 mm, from about 20 mm to about 40 mm, from about 20 mm to about 50 mm, from about 25 mm to about 35 mm, from about 25 mm to about 50 mm, from about 25 mm to about 75 mm, from about 25 mm to about 100 mm, from about 30 mm to about 35 mm, from about 30 mm to about 40 mm, from about 30 mm to about 45 mm, from about 30 mm to about 50 mm, from about 30 mm to about 60 mm, from about 30 mm to about 75 mm, from about 30 mm to about 100 mm, from about 35 mm to about 40 mm, from about 35 mm to about 45 mm, from about 35 mm to about 50 mm, from about 35 mm to about 60 mm, from about 40 mm to about 50 mm, from about 40 mm to about 60 mm, from about 50 mm to about 75 mm, from about 50 mm to about 90 mm, from about 50 mm to about 100 mm, from about 50 mm to about 150 mm, from about 60 mm to about 75 mm, from about 60 mm to about 80 mm, from about 60 mm to about 100 mm, from about 70 mm to about 80 mm, from about 70 mm to about 100 mm, from about 75 mm to about 100 mm, from about 75 mm to about 125 mm, from about 100 mm to about 150 mm, from about 125 mm to about 150 mm, about 10 mm, about 15 mm, about 20 mm, about 25 mm, about 30 mm, about 32 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 110 mm, about 120 mm, about 130 mm, about 140 mm, or about 150 mm). In one embodiment, the length is about 32 mm.

In one embodiment, the volume of each compartment is about 15 mL, the width of each compartment is about 23 mm, and the length of each compartment is about 32 mm.

In some embodiments, each compartment 111 has a diameter from about 10 mm to about 100 mm (e.g., from about 10 mm to about 20 mm, from about 10 mm to about 25 mm, from about 10 mm to about 30 mm, from about 10 mm to about 40 mm, from about 10 mm to about 50 mm, from about 10 mm to about 75 mm, from about 10 mm to about 100 mm, from about 15 mm to about 25 mm, from about 15 mm to about 30 mm, from about 15 mm to about 50 mm, from about 20 mm to about 30 mm, from about 20 mm to about 40 mm, from about 20 mm to about 50 mm, from about 25 mm to about 35 mm, from about 25 mm to about 50 mm, from about 25 mm to about 75 mm, from about 25 mm to about 100 mm, from about 30 mm to about 35 mm, from about 30 mm to about 40 mm, from about 30 mm to about 45 mm, from about 30 mm to about 50 mm, from about 30 mm to about 60 mm, from about 30 mm to about 75 mm, from about 30 mm to about 100 mm, from about 35 mm to about 40 mm, from about 35 mm to about 45 mm, from about 35 mm to about 50 mm, from about 35 mm to about 60 mm, from about 40 mm to about 50 mm, from about 40 mm to about 60 mm, from about 50 mm to about 75 mm, from about 50 mm to about 100 mm, from about 60 mm to about 75 mm, from about 75 mm to about 100 mm, about 10 mm, about 15 mm, about 20 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, or about 100 mm).

In some embodiments, each compartment 111 includes a maximum length, a maximum width, and a maximum height.

In some embodiments, the maximum width of each compartment 111 can be from about 10 mm to about 150 mm (e.g., from about 10 mm to about 20 mm, from about 10 mm to about 25 mm, from about 10 mm to about 30 mm, from about 10 mm to about 40 mm, from about 10 mm to about 50 mm, from about 10 mm to about 75 mm, from about 10 mm to about 100 mm, from about 15 mm to about 25 mm, from about 15 mm to about 30 mm, from about 15 mm to about 50 mm, from about 20 mm to about 30 mm, from about 20 mm to about 40 mm, from about 20 mm to about 50 mm, from about 25 mm to about 35 mm, from about 25 mm to about 50 mm, from about 25 mm to about 75 mm, from about 25 mm to about 100 mm, from about 30 mm to about 35 mm, from about 30 mm to about 40 mm, from about 30 mm to about 45 mm, from about 30 mm to about 50 mm, from about 30 mm to about 60 mm, from about 30 mm to about 75 mm, from about 30 mm to about 100 mm, from about 35 mm to about 40 mm, from about 35 mm to about 45 mm, from about 35 mm to about 50 mm, from about 35 mm to about 60 mm, from about 40 mm to about 50 mm, from about 40 mm to about 60 mm, from about 50 mm to about 75 mm, from about 50 mm to about 90 mm, from about 50 mm to about 100 mm, from about 50 mm to about 150 mm, from about 60 mm to about 75 mm, from about 60 mm to about 80 mm, from about 60 mm to about 100 mm, from about 70 mm to about 80 mm, from about 70 mm to about 100 mm, from about 75 mm to about 100 mm, from about 75 mm to about 125 mm, from about 100 mm to about 150 mm, from about 125 mm to about 150 mm, about 10 mm, about 15 mm, about 20 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 110 mm, about 120 mm, about 130 mm, about 140 mm, or about 150 mm).

In some embodiments, the maximum length of each compartment 111 is from about 10 mm to about 150 mm (e.g., from about 10 mm to about 20 mm, from about 10 mm to about 25 mm, from about 10 mm to about 30 mm, from about 10 mm to about 40 mm, from about 10 mm to about 50 mm, from about 10 mm to about 75 mm, from about 10 mm to about 100 mm, from about 15 mm to about 25 mm, from about 15 mm to about 30 mm, from about 15 mm to about 50 mm, from about 20 mm to about 30 mm, from about 20 mm to about 40 mm, from about 20 mm to about 50 mm, from about 25 mm to about 35 mm, from about 25 mm to about 50 mm, from about 25 mm to about 75 mm, from about 25 mm to about 100 mm, from about 30 mm to about 35 mm, from about 30 mm to about 40 mm, from about 30 mm to about 45 mm, from about 30 mm to about 50 mm, from about 30 mm to about 60 mm, from about 30 mm to about 75 mm, from about 30 mm to about 100 mm, from about 35 mm to about 40 mm, from about 35 mm to about 45 mm, from about 35 mm to about 50 mm, from about 35 mm to about 60 mm, from about 40 mm to about 50 mm, from about 40 mm to about 60 mm, from about 50 mm to about 75 mm, from about 50 mm to about 90 mm, from about 50 mm to about 100 mm, from about 50 mm to about 150 mm, from about 60 mm to about 75 mm, from about 60 mm to about 80 mm, from about 60 mm to about 100 mm, from about 70 mm to about 80 mm, from about 70 mm to about 100 mm, from about 75 mm to about 100 mm, from about 75 mm to about 125 mm, from about 100 mm to about 150 mm, from about 125 mm to about 150 mm, about 10 mm, about 15 mm, about 20 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 110 mm, about 120 mm, about 130 mm, about 140 mm, or about 150 mm).

In some embodiments, the maximum height of each compartment 111 can be from about 10 mm to about 150 mm (e.g., from about 10 mm to about 20 mm, from about 10 mm to about 25 mm, from about 10 mm to about 30 mm, from about 10 mm to about 40 mm, from about 10 mm to about 50 mm, from about 10 mm to about 75 mm, from about 10 mm to about 100 mm, from about 15 mm to about 25 mm, from about 15 mm to about 30 mm, from about 15 mm to about 50 mm, from about 20 mm to about 30 mm, from about 20 mm to about 40 mm, from about 20 mm to about 50 mm, from about 25 mm to about 35 mm, from about 25 mm to about 50 mm, from about 25 mm to about 75 mm, from about 25 mm to about 100 mm, from about 30 mm to about 35 mm, from about 30 mm to about 40 mm, from about 30 mm to about 45 mm, from about 30 mm to about 50 mm, from about 30 mm to about 60 mm, from about 30 mm to about 75 mm, from about 30 mm to about 100 mm, from about 35 mm to about 40 mm, from about 35 mm to about 45 mm, from about 35 mm to about 50 mm, from about 35 mm to about 60 mm, from about 40 mm to about 50 mm, from about 40 mm to about 60 mm, from about 50 mm to about 75 mm, from about 50 mm to about 90 mm, from about 50 mm to about 100 mm, from about 50 mm to about 150 mm, from about 60 mm to about 75 mm, from about 60 mm to about 80 mm, from about 60 mm to about 100 mm, from about 70 mm to about 80 mm, from about 70 mm to about 100 mm, from about 75 mm to about 100 mm, from about 75 mm to about 125 mm, from about 100 mm to about 150 mm, from about 125 mm to about 150 mm, about 10 mm, about 15 mm, about 20 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 110 mm, about 120 mm, about 130 mm, about 140 mm, or about 150 mm).

In some embodiments, each compartment 111 has a maximum diameter from about 10 mm to about 100 mm (e.g., from about 10 mm to about 20 mm, from about 10 mm to about 25 mm, from about 10 mm to about 30 mm, from about 10 mm to about 40 mm, from about 10 mm to about 50 mm, from about 10 mm to about 75 mm, from about 10 mm to about 100 mm, from about 15 mm to about 25 mm, from about 15 mm to about 30 mm, from about 15 mm to about 50 mm, from about 20 mm to about 30 mm, from about 20 mm to about 40 mm, from about 20 mm to about 50 mm, from about 25 mm to about 35 mm, from about 25 mm to about 50 mm, from about 25 mm to about 75 mm, from about 25 mm to about 100 mm, from about 30 mm to about 35 mm, from about 30 mm to about 40 mm, from about 30 mm to about 45 mm, from about 30 mm to about 50 mm, from about 30 mm to about 60 mm, from about 30 mm to about 75 mm, from about 30 mm to about 100 mm, from about 35 mm to about 40 mm, from about 35 mm to about 45 mm, from about 35 mm to about 50 mm, from about 35 mm to about 60 mm, from about 40 mm to about 50 mm, from about 40 mm to about 60 mm, from about 50 mm to about 75 mm, from about 50 mm to about 100 mm, from about 60 mm to about 75 mm, from about 75 mm to about 100 mm, about 10 mm, about 15 mm, about 20 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, or about 100 mm).

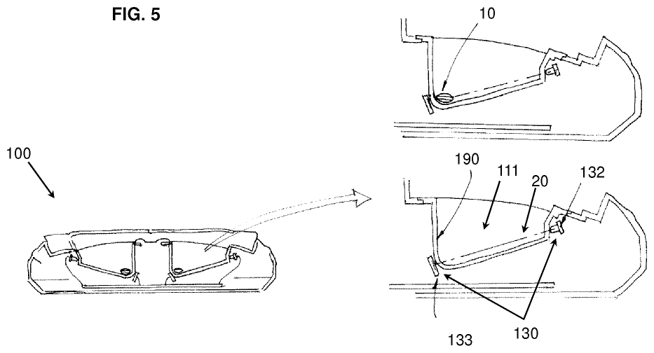

In some embodiments, each compartment 111 includes an optical sensor. FIG. 5 shows an embodiment in which optical sensor 130 is disposed in compartment 111, situated behind inner surface 112, in particular behind transparent surface 190 of inner surface 112. In some embodiments, each compartment 111 includes sensor cover 140. Transparent surface 190 may include a glass or polymeric material. In some embodiments, the polymeric material includes acrylonitrile butadiene styrene (ABS), polyoxymethylene, acrylic, cellulose, ethylene tetrafluoroethylene (ETFE), ethylene-vinyl acetate (EVA), fluorinated ethylene propylene (FEP), high density polyethylene (HDPE), low density polyethylene (LDPE), nylon, polycyclohexylenedimethylene terephthalate (PCTG), polyether ether ketone (PEEK), polyetherimide (PEI), polyetherketoneketone (PEKK), polyethylene terephthalate (PETG), polyethylene terephthalate (PETT), perfluoroalkoxy alkane (PFA), polylactic acid, polycarbonate, polyester, polyethylene, polypropylene, polysulfone, polytetrafluoroethylene (PTFE), polyvinyl chloride (PVC), polyvinylidene fluoride (PVDF), or a combination thereof.

Opening of all compartments 111 at once can trigger a “Refill Mode,” in which compartments 111 can be filled with new medication such as pills 20, tablets, or capsules. Closing of all compartments 111 can end “Refill Mode.”

### Lid

Medication container 100 includes at least one lid 120, as shown in FIG. 1. Lid 120 is configured to open and close to access compartment 111.

Medication container 100 can include from 1 to 50 lids 120 (e.g., from 1 to 2, from 1 to 3, from 1 to 4, from 1 to 5, from 1 to 6, from 1 to 7, from 1 to 8, from 1 to 9, from 1 to 10, from 1 to 11, from 1 to 12, from 1 to 13, from 1 to 14, from 1 to 15, from 1 to 16, from 1 to 17, from 1 to 18, from 1 to 19, from 1 to 20, from 2 to 3, from 2 to 4, from 2 to 5, from 2 to 6, from 4 to 8, from 4 to 10, from 4 to 12, from 4 to 16, from 2 to 14, from 2 to 16, from 2 to 18, from 2 to 18, from 2 to 20, from 2 to 22, from 2 to 24, from 5 to 8, from 5 to 7, from 5 to 10, from 6 to 8, from 6 to 10, from 6 to 12, from 6 to 14, from 6 to 16, from 6 to 18, from 6 to 20, from 6 to 22, from 6 to 24, from 7 to 14, from 8 to 10, from 8 to 12, from 8 to 14, from 8 to 16, from 8 to 18, from 8 to 20, from 8 to 22, from 8 to 24, from 10 to 12, from 10 to 14, from 10 to 16, from 10 to 18, from 10 to 20, from 10 to 22, from 10 to 24, from 10 to 30, from 10 to 40, from 10 to 50, from 12 to 14, from 12 to 16, from 12 to 18, from 12 to 20, from 12 to 22, from 12 to 24, from 14 to 16, from 14 to 18, from 14 to 20, from 14 to 22, from 14 to 24, from 16 to 20, from 16 to 32, from 20 to 40, from 30 to 40, from 30 to 50, from 40 to 50, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50) lids. In some embodiments, each compartment 111 includes a lid 120. In some embodiments, a plurality of compartments 111 (e.g., 2, 3, 4, 5, 6, 7, 8, 9, or 10) share a lid 120. In some embodiments, medication container 100 includes one lid 120.

In some embodiments, each lid 120 includes optical sensor 130. In some embodiments, each lid 120 includes sensor cover 140. Sensor cover 140 can be disposed on the underside of at least one lid 120. In other embodiments, sensor cover 140 can be disposed at an end of lid 120.

In some embodiments, each lid 120 is hingeably attached to housing 110. In some embodiments, housing 110 and lid 120 are hingeably attached with a hinge. In some embodiments, each lid 120 is slidably attached to housing 110. In some embodiments, housing 110 includes a groove through which at least one lid 120 is configured to slide.

In some embodiments, lid 120 includes a polymeric material. In some embodiments, the polymeric material is acrylic (PMMA), acrylonitrile butadiene styrene (ABS), nylon polyamide (PA), polycarbonate (PC), polyethylene (PE), polyoxymethylene (POM), polypropylene (PP), polystyrene (PS), thermoplastic elastomer (TPE), thermoplastic polyurethane (TPU), or a combination thereof. In some embodiments, lid 120 can be fabricated through injection molding or additive manufacturing, such as 3D-printing.

### Optical Sensor

Medication container 100 includes at least one optical sensor 130, as shown in FIG. 3. In some embodiments, medication container 100 includes from 1 to 20 optical sensors 130 (e.g., from 1 to 2, from 1 to 4, from 1 to 5, from 1 to 7, from 1 to 10, from 1 to 14, from 1 to 15, from 2 to 7, from 2 to 14, from 4 to 14, from 5 to 7, from 5 to 10, from 6 to 14, from 7 to 14, from 8 to 14, from 10 to 14, from 10 to 20, from 14 to 20, 1, 2, 3, 4, 5, 6, 7, 8, 9, 10, 11, 12, 13, 14, 15, 16, 17, 18, 19 or 20).

In some embodiments, optical sensor 130 includes a charge-coupling device (CCD) or a complementary metal-oxide semiconductor (CMOS). In some embodiments, optical sensor 130 includes a camera, a light sensor, a photocell, a photodiode, a photoresistor, a phototransistor, a photomultiplier tube, a digital image sensor, or a color sensor.

In some embodiments, optical sensor 130 includes emitter 132 and detector 133, as shown in FIG. 5. In particular, FIG. 5 shows medication container 100, including compartment 111 having pill 10 disposed therein, optical sensor 130 including emitter 132 and detector 133. Emitter 132 and/or detector 133 may be disposed behind inner surface 112 including transparent surface 190. FIG. 5 shows that detector 133 detects light 20 emitted from emitter 132. FIG. 5 further shows that pill 10 blocks emitted light 20 from emitter 132 such that detector 133 cannot detect it.

In some embodiments, each compartment 111 or lid 120 includes optical sensor 130. In some embodiments, each compartment 111 or lid 120 includes from 1 to 10 optical sensors 130 (e.g., from 1 to 2, from 1 to 4, from 1 to 5, from 1 to 8, from 2 to 3, from 2 to 4, from 2 to 5, from 2 to 6, from 2 to 8, from 3 to 4, from 3 to 5, from 3 to 6, from 4 to 6, from 5 to 10, 1, 2, 3, 4, 5, 6, 7, 8, 9, or 10).

In some embodiments, optical sensor 130 is disposed on at least one inner surface 112. In some embodiments, optical sensor 130 is disposed in at least one compartment 111. In some embodiments, optical sensor 130 is covered by a transparent surface.

In some embodiments, optical sensor 130 is in a cavity. In some embodiments, the cavity includes a volume from about 0.1 mL to about 100 mL (e.g., from about 0.1 mL to about 0.5 mL, from about 0.1 mL to about 1 mL, from about 0.1 mL to about 2 mL, from about 0.5 mL to about 1 mL, from about 0.5 mL to about 2 mL, from about 0.5 mL to about 5 mL, from about 1 mL to about 10 mL, from about 1 mL to about 10 mL, from about 5 mL to about 10 mL, from about 5 mL to about 20 mL, from about 5 mL to about 25 mL, from about 5 mL to about 40 mL, from about 5 mL to about 50 mL, from about 10 mL to about 20 mL, from about 10 mL to about 30 mL, from about 10 mL to about 40 mL, from about 10 mL to about 50 mL, from about 10 mL to about 100 mL, from about 15 mL to about 30 mL, from about 20 mL to about 30 mL, from about 20 mL to about 35 mL, from about 20 mL to about 40 mL, from about 20 mL to about 50 mL, from about 25 mL to about 50 mL, from about 25 mL to about 75 mL, from about 25 mL to about 100 mL, from about 30 mL to about 35 mL, from about 30 mL to about 40 mL, from about 30 mL to about 50 mL, from about 30 mL to about 75 mL, from about 30 mL to about 100 mL, from about 40 mL to about 50 mL, from about 50 mL to about 75 mL, from about 50 mL to about 100 mL, from about 60 mL to about 75 mL, from about 70 mL to about 90 mL, from about 80 mL to about 100 mL, or from about 90 mL to about 100 mL, about 0.1 mL, about 0.2 mL, about 0.3 mL, about 0.4 mL, about 0.5 mL, about 0.6 mL, about 0.7 mL, about 0.8 mL, about 0.9 mL, about 1 mL, about 2 mL, about 3 mL, about 4 mL, about 5 mL, about 10 mL, about 15 mL, about 20 mL, about 25 mL, about 30 mL, about 35 mL, about 40 mL, about 45 mL, about 50 mL, about 55 mL, about 60 mL, about 65 mL, about 70 mL, about 75 mL, about 80 mL, about 85 mL, about 90 mL, about 95 mL, or about 100 mL). The volume of the cavity is defined as the space between optical sensor 130 and a plane at an upper end of the cavity.

In some embodiments, the optical sensor 130 can detect light greater than about 10 lux (e.g., about 15 lux, about 20 lux, about 25 lux, about 30 lux, about 35 lux, about 40 lux, about 45 lux, about 50 lux, about 60 lux, about 70 lux, about 80 lux, about 90 lux, about 100 lux, about 150 lux, about 200 lux, about 250 lux, about 300 lux, about 400 lux, about 500 lux, about 750 lux, about 1000 lux, about 1500 lux, about 2500 lux, about 5000 lux, etc.) In some embodiments, the optical sensor 130 can detect light from about 10 lux to about 10,000 lux (e.g., about 15 lux to about 10,000 lux, about 20 lux to about 10,000 lux, about 25 lux to about 10,000 lux, about 30 lux to about 10,000 lux, about 40 lux to about 10,000 lux, about 50 lux to about 10,000 lux, about 75 lux to about 10,000 lux, about 100 lux to about 10,000 lux, or about 500 lux to about 10,000 lux).

In some embodiments, the optical sensor 130 can detect a difference between a first light level and a second light level. In particular, the optical sensor can detect a light differential between light in a closed state and an open state of a lid of medication container 100. In some embodiments, the difference between the first light level and the second light level is at least about 0.1 lux (e.g., about 0.2 lux, about 0.3 lux, about 0.4 lux, about 0.5 lux, about 0.6 lux, about 0.7 lux, about 0.8 lux, about 0.9 lux, about 1 lux, about 2 lux, about 3 lux, about 4 lux, about 5 lux, about 6 lux, about 7 lux, about 8 lux, about 9 lux, about 10 lux, about 15 lux, about 20 lux, about 25 lux, about 30 lux, about 40 lux, about 50 lux, about 100 lux, etc.) In some embodiments, the difference between the first light level and the second light level is from about 0.01 lux to about 100 lux (e.g., about 0.01 lux to about 0.1 lux, about 0.01 lux to about 0.5 lux, about 0.01 lux to about 1 lux, about 0.01 lux to about 5 lux, about 0.1 lux to about 0.5 lux, about 0.1 lux to about 1 lux, about 0.5 lux to about 1 lux, about 0.5 lux to about 2.5 lux, about 0.5 lux to about 5 lux, about 1 lux to about 5 lux, about 1 lux to about 10 lux, about 1 lux to about 25 lux, about 5 lux to about 25 lux, about 10 lux to about 100 lux, about 15 lux to about 30 lux, about 15 lux to about 100 lux, about 20 lux to about 100 lux, about 25 lux to about 50 lux, about 25 lux to about 100 lux, about 30 lux to about 100 lux, about 40 lux to about 100 lux, about 50 lux to about 100 lux, about 75 lux to about 100 lux, about 0.01 lux, about 0.05 lux, about 0.1 lux, about 0.2 lux, about 0.3 lux, about 0.4 lux, about 0.5 lux, about 0.6 lux, about 0.7 lux, about 0.8 lux, about 0.9 lux, about 1 lux, about 2 lux, about 3 lux, about 4 lux, about 5 lux, about 6 lux, about 7 lux, about 8 lux, about 9 lux, about 10 lux, about 15 lux, about 20 lux, about 25 lux, about 30 lux, about 40 lux, about 50 lux, or about 100 lux).

In some embodiments, optical sensor 130 includes sensor surface 131, as shown in FIG. 3. In some embodiments, sensor surface 131 is rounded or flat. In some embodiments, sensor surface 131 includes a glass or polymeric material. In some embodiments, the polymeric material includes acrylonitrile butadiene styrene (ABS), polyoxymethylene, acrylic, cellulose, ethylene tetrafluoroethylene (ETFE), ethylene-vinyl acetate (EVA), fluorinated ethylene propylene (FEP), high density polyethylene (HDPE), low density polyethylene (LDPE), nylon, polycyclohexylenedimethylene terephthalate (PCTG), polyether ether ketone (PEEK), polyetherimide (PEI), polyetherketoneketone (PEKK), polyethylene terephthalate (PETG), polyethylene terephthalate (PETT), perfluoroalkoxy alkane (PFA), polylactic acid, polycarbonate, polyester, polyethylene, polypropylene, polysulfone, polytetrafluoroethylene (PTFE), polyvinyl chloride (PVC), polyvinylidene fluoride (PVDF), or a combination thereof.

In some embodiments, sensor surface 131 allows transmission of greater than 50%, 60%, 70%, 80%, 90%, 95%, or 99% of ambient light.

### Sensor Cover

Medication container 100 includes at least one sensor cover 140, as shown in FIG. 3. Sensor cover 140 is configured to cover optical sensor 130 from ambient light when medication container 100 is closed. Including sensor cover 140 in the medication container is advantageous as it enables the gathering of more accurate optical sensor 130 data, thereby more accurately recording compliance to the medication regimen by the patient.

In some embodiments, sensor cover 140 is disposed on housing 110, e.g. on upper surface 115. In some embodiments, sensor cover 140 is disposed in at least one compartment, e.g., on inner surface 112. In some embodiments, sensor cover 140 is disposed on at least one inner surface 112.

In some embodiments, sensor cover 140 is disposed on lid 120, e.g., on the underside of lid 120.

In some embodiments, each compartment 111 or lid 120 includes one or more sensor covers 140.

In some embodiments, the medication container 100 includes from 1 to 20 sensor covers (e.g., from 1 to 2, from 1 to 4, from 1 to 5, from 1 to 7, from 1 to 10, from 1 to 14, from 1 to 15, from 2 to 7, from 2 to 14, from 4 to 14, from 5 to 7, from 5 to 10, from 6 to 14, from 7 to 14, from 8 to 14, from 10 to 14, from 10 to 20, from 14 to 20, 1, 2, 3, 4, 5, 6, 7, 8, 9, 10, 11, 12, 13, 14, 15, 16, 17, 18, 19 or 20).

In some embodiments, sensor cover 140 includes a surface. In some embodiments, sensor cover 140, e.g., the surface, is concave, curved, rounded, triangular, rectangular, or cuboidal. In some embodiments, sensor cover 140 includes a protrusion.

In some embodiments, sensor cover 140 is configured to nestably or slidably mate with optical sensor 130. In some embodiments, sensor cover 140 is configured to slidably engage optical sensor 130.

In some embodiments, upon closure of lid 120, optical sensor 130 is disposed in a dark chamber. In some embodiments, sensor cover 140 blocks greater than 50%, 60%, 70%, 80%, 90%, 95%, or 99% of ambient light from optical sensor 130 when lid 120 is closed.

In some embodiments, sensor cover 140 includes a sensor cavity. In some embodiments, optical sensor 130 is configured to nestably mate with the sensor cavity. In some embodiments, the volume of the cavity is no more than 25%, 20%, 15%, 10%, 5%, or 1% larger than the volume of optical sensor 130. In some embodiments, the sensory cavity includes a volume from about 0.1 mL to about 100 ml (e.g., from about 0.1 mL to about 0.5 mL, from about 0.1 mL to about 1 mL, from about 0.1 mL to about 2 mL, from about 0.5 mL to about 1 mL, from about 0.5 mL to about 2 mL, from about 0.5 mL to about 5 mL, from about 1 mL to about 10 mL, from about 1 mL to about 10 mL, from about 5 mL to about 10 mL, from about 5 mL to about 20 mL, from about 5 mL to about 25 mL, from about 5 mL to about 40 mL, from about 5 mL to about 50 mL, from about 10 mL to about 20 mL, from about 10 mL to about 30 mL, from about 10 mL to about 40 mL, from about 10 mL to about 50 mL, from about 10 mL to about 100 mL, from about 15 mL to about 30 mL, from about 20 mL to about 30 mL, from about 20 mL to about 35 mL, from about 20 mL to about 40 mL, from about 20 mL to about 50 mL, from about 25 mL to about 50 mL, from about 25 mL to about 75 mL, from about 25 mL to about 100 mL, from about 30 mL to about 35 mL, from about 30 mL to about 40 mL, from about 30 mL to about 50 mL, from about 30 mL to about 75 mL, from about 30 mL to about 100 mL, from about 40 mL to about 50 mL, from about 50 mL to about 75 mL, from about 50 mL to about 100 mL, from about 60 mL to about 75 mL, from about 70 mL to about 90 mL, from about 80 mL to about 100 mL, or from about 90 mL to about 100 mL, about 0.1 mL, about 0.2 mL, about 0.3 mL, about 0.4 mL, about 0.5 mL, about 0.6 mL, about 0.7 mL, about 0.8 mL, about 0.9 mL, about 1 mL, about 2 mL, about 3 mL, about 4 mL, about 5 mL, about 10 mL, about 15 mL, about 20 mL, about 25 mL, about 30 mL, about 35 mL, about 40 mL, about 45 mL, about 50 mL, about 55 mL, about 60 mL, about 65 mL, about 70 mL, about 75 mL, about 80 mL, about 85 mL, about 90 mL, about 95 mL, or about 100 mL).

In some embodiments, optical sensor 130 is in a cavity. In some embodiments, sensor cover 140 is configured to cover or fill the cavity upon closure of at least one lid. In some embodiments, the volume of the cavity above optical sensor 130 is no more than 25%, 20%, 15%, 10%, 5%, or 1% larger than the volume of sensor cover 140.

In some embodiments, upon closure of lid 120, sensor cover 140 conforms to the shape of optical sensor 130. In some embodiments, upon closure of lid 120, optical sensor 130 is substantially surrounded by sensor cover 140.

In some embodiments, sensor cover 140 includes a light filter. In some embodiments, the light filter blocks greater than 50%, 60%, 70%, 80%, 90%, 95%, or 99% of ambient light. In some embodiments, the light filter is frosted or opaque. In some embodiments, the light filter is polymeric, e.g., includes polyester, polystyrene, acrylic, or polycarbonate.

In some embodiments, sensor cover 140 is integral to lid 120 or housing 110. In some embodiments, sensor cover 140 is removably attached to lid 120 or housing 110. In some embodiments, sensor cover 140 clips, snaps, or screws into lid 120 or housing 110.

In some embodiments, sensor cover 140 includes a polymeric material. In some embodiments, the polymeric material is acrylic (PMMA), acrylonitrile butadiene styrene (ABS), nylon polyamide (PA), polycarbonate (PC), polyethylene (PE), polyoxymethylene (POM), polypropylene (PP), polystyrene (PS), thermoplastic elastomer (TPE), thermoplastic polyurethane (TPU), or a combination thereof. In some embodiments, sensor cover 140 can be fabricated through injection molding or additive manufacturing, such as 3D-printing.

### Indicator

In some embodiments, indicator 150 is a symbol, a light, an embossment, or an indent. Indicators 150 are configured to aid the patient in using medication container 100. FIG. 2 shows medication container 100, including indicator letter 151, indicator image 152, indicator embossment 153, and indicator light 154.

In some embodiments, the embossment is Braille. Braille can be advantageous for blind patients. In some embodiments, as shown in FIG. 2, the embossment indicates the location of button 180. An embossment on button 180 is advantageous in indicating the location of button 180 on medication container 100.

In some embodiments, the symbol is a letter or number. A letter or number can be advantageous in indicating to the patient which compartment 111 should be opened, and when. In some embodiments, the letter is indicative of the day of the week or month. In some embodiments, the number is indicative of the day of the week or month.

In some embodiments, the symbol is an image. An image can be advantageous in indicating to the patient which compartment 111 should be opened, and when. In some embodiments, the image is of a sun or moon, as shown in FIG. 2. In some embodiments, the sun is indicative of day. In some embodiments, the moon is indicative of night.

In some embodiments, the light is an LED, as shown in FIG. 2. A light can be advantageous in indicating to the patient which compartment 111 should be opened, and when. Indicator light 154 can turn a plurality of colors. In some embodiments, indicator light 154 can turn a first color, e.g., red, orange, yellow, green, blue, purple, pink, or white. In some embodiments, indicator light 154 can turn a second color, e.g., red, orange, yellow, green, blue, purple, pink, or white. The colors can indicate different statuses of the medication schedule. For example, green can indicate a dose soon to be taken, and red can indicate a missed dose.

In some embodiments, the indicator is on at least one lid 120 or compartment 111. In some embodiments, housing 110 or at least one lid 120 includes at least one indicator light 154. In some embodiments, each compartment 111 and/or each lid 120 includes an indicator light 154, as shown in FIG. 2.

### Button

In some embodiments, each lid 120 includes button 180 or switch to open the corresponding compartment 111. Button 180 is configured to open at least one compartment 111. Button 180 can open a plurality of compartments. In some embodiments, button 180 is spring-loaded.

In some embodiments, button 180 includes a fingerprint reader. A fingerprint reader can be advantageous such that solely the patient can open compartment 111. A fingerprint reader can be especially advantageous for patients living in group settings.

In some embodiments, button 180 includes an indicator 150, such as an indicator embossment 153.

### Processor and Transmitter

In some embodiments, the processor is configured to determine a positive or negative medication adherence event by a subject based on at least one measurement taken by optical sensor 130.

In some embodiments, the processor is configured to receive a signal from an external device. In some embodiments, the transmitter is configured to wirelessly send a signal to an external device. In some embodiments, the signal corresponds to a positive or a negative medication adherence event. In some embodiments, the signal is an alert to a caregiver or healthcare professional regarding a positive or negative medication adherence event.

In some embodiments, the transmission element is a BLUETOOTH® transmission element. In some embodiments, the transmission element is a wireless networking transmission element.

In some embodiments, the processor is configured to turn on a light based on a medication regime received from an external device, in which the light corresponds to a medication to be taken by a subject. In some embodiments, each compartment or lid includes a light. In some embodiments, the light is an LED.

In some embodiments, the processor is configured to send a reminder of a scheduled medication dose to a subject. In some embodiments, the reminder is an alert. In some embodiments, the alert is auditory or visual. The auditory alert can be issued from medication container 100, or from an external device, such as a personal computer, a cellular phone, a tablet, or a speaker. The visual alert can be used from medication container 100, such as on a screen, or from an external computer, such as a personal computer, a cellular phone, a tablet, or a speaker.

### Alerts

In some embodiments, the medication container further includes an auditory alert. In some embodiments, the auditory alert is bell, chime, or buzzer. In some embodiments, the processor is configured to turn on the auditory alert based on a medication regime received from an external device. In some embodiments, the medication container further includes a visual alert. In some embodiments, the visual alert is a light, such as an LED, or an image on a screen. In some embodiments, the processor is configured to turn on the visual alert based on a medication regime received from an external computer.

### Methods of Use

Also featured are methods of using medication container 100.

The present disclosure features a method of monitoring medication compliance, including (i) providing the medication container of the present disclosure; (ii) providing a medication schedule to the processor; (ii) sensing ambient light with optical sensor 130, in which ambient light corresponds to a positive medication incident; and (iii) sending a signal to an external device, in which the signal corresponds to the positive medication incident.

In some embodiments, the medication schedule is provided to the processor on a screen on medication container 100. In some embodiments, the medication schedule is provided to the processor from a first external device. In some embodiments, the medication schedule is provided to the processor from an application on the first external device.

The present disclosure features a method of monitoring medication compliance, including (i) providing the medication container of the present disclosure; (ii) providing a medication schedule to the processor from a first external device; (ii) sensing ambient light with optical sensor 130, in which ambient light corresponds to a positive medication incident; and (iii) sending a signal to the first external device or a second external device with the transmitter, in which the signal corresponds to the positive medication incident.

In some embodiments, the medication schedule is provided to the processor by a patient.

In some embodiments, the external device, e.g., the first or second external device, is a personal computer, a tablet, a cellular phone, a pharmacy computer, or a patient information database.

In some embodiments, the method further includes providing a picture of pill 20, capsule or tablet to the processor from an external device. In some embodiments, the method further includes providing a side effect to the processor from an external device. In some embodiments, the method further includes providing instructions on taking medication to the processor from an external device. In some embodiments, the method further includes instructions to take medication with food and/or water to the processor from an external device.

In some embodiments, the medication schedule includes a scheduled medication dose, in which the medication container includes at least one light, and in which processor turns on the light prior to a scheduled medication dose. In some embodiments, the light is an LED.

In some embodiments, the medication schedule includes a scheduled medication dose, in which the medication container includes an auditory alert, and in which processor turns on the auditory alert prior to a scheduled medication dose. In some embodiments, the auditory alert is bell, chime, or buzzer. In some embodiments, the signal is sent to an external computer, e.g., a personal computer, a cellular phone, a tablet, or a speaker, of a caregiver or healthcare professional.

The present disclosure features a method of refilling medication container 100, including (i) providing the medication container of the present disclosure; (ii) opening at least one compartment 111; and (iii) placing at least one pill 10, tablet, or capsule in at least one compartment 111.

In some embodiments, opening of all of the plurality of lids 120 initiates a “Refill Mode.” In some embodiments, the method includes opening of all of the plurality of lids 120, in which opening all of the plurality of lids 120 stops optical sensor 130 from sensing ambient light. In some embodiments, the method includes closing of all of the plurality of lids 120, in which closing all of the plurality of lids 120 initiates optical sensor 130 to sense ambient light.

### EXAMPLES

The following examples are put forth so as to provide those of ordinary skill in the art with a description of how the compositions and methods described herein can be used, made, and evaluated, and are intended to be purely exemplary of the disclosure and are not intended to limit the scope of what the inventors regard as their invention.

### Example 1. Use of Device 100

The present Example demonstrates an exemplary medication container 100 and use thereof.

Medication container 100 includes 14 compartments 111, distributed in 7 columns and 2 rows. Each column of medication container 100 corresponds to a day of the week (from Monday to Sunday) and each row corresponds to a time (AM and PM). Each compartment 111 has a lid 120 that can be opened and closed. Optical sensor 130, in particular a photoresistor, is placed within each compartment 111 to monitor when lid 120 is opened, in some embodiments, with a server as an intermediate. Indicator light 154, in particular an LED, is placed near each lid 120. Indicator lights 154 are used to provide information to the patient about which compartment should be opened.

Medication container 100 can be wirelessly connected to an external computer. Medication container 100 can be wirelessly connected to any external device, e.g., an electronic device, with iOS or Android compatibility, e.g., a smartphone or a tablet. An application having software running on the external device, e.g., mobile device, allows the user to program a medication schedule onto medication container 100.

The user can be any person inputting the medication schedule onto medication container 100. The patient can be any person following the medication schedule and taking the medication (e.g., pill 20). The user and patient can be the same person.

All programming can be completed through the application running on external device, e.g., the mobile device. Through the application interface, the user can input the information for each of the 14 bins.

Information that can be input into medication container 100 includes i) wireless connection information, including wireless network (e.g., Wi-Fi or Bluetooth) information; ii) medication schedule, including times at which particular medication must be taken; iii) dosage information, including the names of the medication to be taken at each of the times, defined by the medication schedule; iii) a picture of each pill 20, tablet, or capsule; iv) side effects; and/or v) special instructions, such that the medication must be taken with food.

Once the information is entered into the application by the user, the information is sent via wireless connection (e.g., Wi-Fi and/or Bluetooth, in some embodiments, with a server as an intermediate), and programmed onto the processor contained within medication container 100.

The processor of medication container 100 can i) monitor the opening of each compartment 111; ii) send reminders to the patient; iii) send alerts to caregivers; and/or iv) enter “Refill Mode”

When compartment 111 is opened, medication container 100 records that at least one pill 20, tablet, or capsule within that compartment 111 has been taken by the patient. A time stamp at the time in which the compartment 111 has been opened is sent to an external computer, cell phone, or tablet via a wireless connection (e.g., Wi-Fi or Bluetooth, in some embodiments, with a server as an intermediate), such that it can be recorded in the application.

Reminders to take medication can be sent to the patient through a visual alert, such as indicator light 154 turning on. Indicator light 154 may turn on green before the dose is scheduled to be taken. Reminders can be sent a few minutes (e.g., 1 to 10 minutes, e.g., 1, 2, 3, 4, 5, 6, 7, 8, 9, or 10 minutes) before a scheduled dose. Indicator light 154 can turn off once compartment 111 has been opened.

If the patient fails to open compartment 111 past a certain time after the scheduled dose, indicator light 154 can change color to red. Indicator light 154 can remain red as long as related compartment 111 has not been opened.

Medication container 100 can send a signal through a wireless network (e.g., Wi-Fi or Bluetooth) to an external computer, cell phone, or tablet triggering an alert (e.g., a push notification) visible by the user. The alert can be done before a scheduled dosage, and after, if the user forgets to open compartment 111.

At the end of a particular period (e.g., a week) the patient needs to refill all the compartments 111. Opening all compartments 111 simultaneously can trigger medication container 100 to enter in “Refill Mode.” When placed in “Refill Mode,” medication container 100 can stop monitoring the medication schedule and indicator lights 154 can flash. Once all compartments 111 have been closed again, medication container 100 can re-enter its normal mode, and can resume monitoring opening of compartments 111.

### Other Embodiments

All publications, patents, and patent applications mentioned in the above specification are hereby incorporated by reference. Various modifications and variations of the described method and system of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention. This application is intended to cover any variations, uses, or adaptations of the invention following, in general, the principles of the invention and including such departures from the present disclosure come within known customary practice within the art to which the invention pertains and can be applied to the essential features herein before set forth.

Other embodiments are within the claims.

1. A medication container comprising:
a housing comprising a plurality of compartments, wherein each compartment comprises (i) an indicator and (ii) a lid, wherein each lid comprises an inner surface;
an optical sensor disposed on the housing or on at least one lid;
a sensor cover configured to shield the optical sensor from ambient light when the at least one lid is closed;
a processor; and
a transmitter;
wherein the sensor cover is configured to mate with the sensor upon closure of the at least one lid.

2. The medication container of claim 1, wherein each compartment or lid comprises an optical sensor.

3. The medication container of claim 1 or 2, wherein each compartment or lid comprises a sensor cover.

4. The medication container of any one of claims 1 to 3, wherein the sensor cover is concave, curved, rounded, triangular, rectangular, or cuboidal.

5. The medication container of any one of claims 1 to 3, wherein the sensor cover comprises a protrusion.

6. The medication container of any one of claims 1 to 5, wherein the sensor cover is configured to nestably or slidably mate with the optical sensor.

7. The medication container of claim 1 or 4, wherein the sensor cover comprises a sensor cavity.

8. The medication container of claim 7, wherein the optical sensor is configured to nestably mate with the sensor cavity.

9. The medication container of claim 7 or 8, wherein the volume of the cavity is no more than 25%, 20%, 15%, 10%, 5%, or 1% larger than the volume of the optical sensor.

10. The medication container of claim 1 or 4, wherein the optical sensor is in a cavity.

11. The medication container of claim 10, wherein the sensor cover is configured to cover or fill the cavity upon closure of at least one lid.

12. The medication container of claim 10 or 11, wherein the volume of the cavity above the optical sensor is no more than 25%, 20%, 15%, 10%, 5%, or 1% larger than the volume of the sensor cover.

13. The medication container of any one of claims 1 to 12, wherein upon closure of the lid, the sensor cover conforms to the shape of the optical sensor.

14. The medication container of any one of claims 1 to 13, wherein upon closure of the lid, the optical sensor is substantially surrounded by the sensor cover.

15. The medication container of any one of claims 1 to 14, wherein optical sensor is disposed on at least one inner surface.

16. The medication container of any one of claims 1 to 15, wherein the optical sensor is disposed in at least one compartment.

17. The medication container of any one of claims 1 to 15, wherein the sensor cover is disposed on the housing.

18. The medication container of any one of claims 1 to 15, wherein the sensor cover is disposed in at least one compartment.

19. The medication container of any one of claims 1 to 15, wherein the sensor cover is disposed on at least one inner surface.

20. The medication container of any one of claims 1 to 19, wherein the sensor cover comprises a light filter.

21. The medication container of claim 20, wherein the light filter blocks greater than 50%, 60%, 70%, 80%, 90%, 95%, or 99% of ambient light.

22. The medication container of any one of claims 1 to 21, wherein the optical sensor comprises a sensor surface.

23. The medication container of claim 22, wherein the sensor surface is rounded or flat.

24. The medication container of claim 22 or 23, wherein the sensor surface allows transmission of greater than 50%, 60%, 70%, 80%, 90%, 95%, or 99% of ambient light.

25. The medication container of any one of claims 1 to 24, wherein each lid is hingeably attached to the housing.

26. The medication container of any one of claims 1 to 24, wherein each lid is slidably attached to the housing.

27. The medication container of claim 26, wherein the housing comprises a groove through which at least one lid is configured to slide.

28. The medication container of claim 26 or 27, wherein the sensor cover is configured to slidably engage the optical sensor.

29. The medication container of any one of claims 1 to 28, wherein the sensor cover is integral to the lid or housing.

30. The medication container of any one of claims 1 to 28, wherein the sensor cover is removably attached to the lid or housing.

31. The medication container of claim 30, wherein the sensor cover clips, snaps, or screws into the lid or housing.

32. The medication container of any one of claims 1 to 31, wherein the optical sensor is a photoresistor.

33. The medication container of any one of claims 1 to 32, wherein the indicator is a symbol, a light emitting diode (LED), an embossment, or an indent.

34. The medication container of claim 33, wherein the embossment is Braille.

35. The medication container of claim 33, wherein the symbol is a letter or number corresponding to the day of the week or month.

36. The medication container of any one of claims 1 to 35, wherein the indicator is on at least one lid or compartment.

37. The medication container of any one of claims 1 to 36, wherein the housing or at least one lid comprises at least one LED.

38. The medication container of claim 37, wherein each compartment and/or each lid comprises an LED.

39. The medication container of any one of claims 1 to 38, wherein the housing comprises between 2 to 30 compartments.

40. The medication container of any one of claims 1 to 39, wherein the housing comprises 14 compartments.

41. The medication container of any one of claims 1 to 40, wherein the plurality of compartments are configured for receiving one or more medications.

42. The medication container of any one of claims 1 to 41, wherein each lid comprises a button or switch to open the corresponding compartment.

43. The medication container of any one of claims 1 to 42, wherein the processor is configured to determine a positive or negative medication adherence event by a subject based on at least one measurement taken by the optical sensor.

44. The medication container of any one of claims 1 to 43, wherein the processor is configured to receive a signal from an external device.

45. The medication container of any one of claims 1 to 44, wherein the transmitter is configured to wirelessly send a signal to an external device.

46. The medication container of claim 45, wherein the signal corresponds to a positive or a negative medication adherence event.

47. The medication storage container of claim 45 or 46, wherein the signal is an alert to a caregiver or healthcare professional regarding a positive or negative medication adherence event.

48. The medication container of any one of claims 1 to 47, wherein the transmission element is a BLUETOOTH® transmission element.

49. The medication container of any one of claims 1 to 48, wherein the processor is configured to turn on an LED based on a medication regime received from an external device, wherein the LED corresponds to a medication to be taken by a subject.

50. The medication container of any one of claims 1 to 49, wherein each compartment or lid comprises an LED.

51. The medication container of any one of claims 1 to 50, wherein the processor is configured to send a reminder of a scheduled medication dose to a subject.

52. The medication container of any one of claims 1 to 51, wherein the medication container further includes an auditory alert, and wherein the processor is configured to turn on the auditory alert based on the medication regime received from an external device.

53. The medication container of claim 52, wherein the auditory alert is bell, chime, or buzzer.

54. The medication container of any one of claims 44 to 53, wherein the external device is a personal computer, a tablet, a cellular phone, a pharmacy computer, or a patient information database.

55. A method of monitoring medication compliance, comprising
(i) providing the medication container of any one of claims 1 to 54;
(ii) providing a medication schedule to the processor from a first external device;
(iii) sensing ambient light with the optical sensor, wherein ambient light corresponds to a positive medication incident; and
(iv) sending a signal to the first external device or a second external device with the transmitter, wherein the signal corresponds to the positive medication incident.

56. The method of claim 55, wherein the medication schedule comprises a scheduled medication dose, wherein the medication container comprises at least one LED, and wherein processor turns on the LED prior to a scheduled medication dose.

57. The method of claim 55 or 56, wherein the medication schedule comprises a scheduled medication dose, wherein the medication container comprises an auditory alert, and wherein processor turns on the auditory alert prior to a scheduled medication dose.

58. The method of claim 57, wherein the auditory alert is bell, chime, or buzzer.

59. The method of any one of claims 55 or 58, wherein the first and/or the second external device is a personal computer, a tablet, a cellular phone, a pharmacy computer, or a patient information database.

60. The method of any one of claims 55 to 59, wherein the signal is sent to an external computer of a caregiver or healthcare professional.

61. The method of claim 60, wherein the external computer is a personal computer, a cellular phone, a tablet, or a speaker.

62. The method of any one of claims 55 to 61, wherein the medication schedule is provided to the processor by a patient.
